(19) United States
(12) Patent Application Publication
(10) Pub. No.: US 2006/0083819 A1
(43) Pub. Date: Apr. 20, 2006

(54) Beer mashing process

(75) Inventors: Hans Sejr Olsen, Holte (DK); Henrik Bisgaard-Frantzen, Bagsvaerd (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/537,558

(22) PCT Filed: Dec. 4, 2003
(86) PCT No.: PCT/DK03/00832

§ 371 Date: Jun. 3, 2005

(30) Foreign Application Priority Data
Dec. 5, 2002 (DK) PA 2002 01876

(51) Int. Cl. C12C 11/00

(52) U.S. Cl. 426/11

(57) ABSTRACT

The present invention provides processes for production of wort and beer wherein the mash liquefaction comprises jet cooking and application of microbial mashing enzymes.

### FIELD OF THE INVENTION

The present invention relates to improved mashing processes for production of a standardized high quality wort and for production of a similarly high quality beer.

### BACKGROUND OF THE INVENTION

Traditionally beer has been brewed from barley malt, hops and water. However, often part of the barley malt is substituted with adjuncts such as corn, rice, sorghum, and wheat, refined starch or readily fermentable carbohydrates such as sugar or syrups. Adjuncts are used mainly because they provide carbohydrates at a lower cost than is available from barley malt. As the adjuncts contribute insufficient or no enzyme activity for the conversion of the grist starch into fermentable sugars, the barley malt must supply the enzyme activity to degrade the barley malt as well as the adjuncts into fermentable sugars and free amino acids for yeast nutrition. Thus in the conventional mashing process the quality of the wort produced is highly dependent on the enzyme activity of the barley malt used. However, if a mashing process for producing a high quality wort and beer could be provided, wherein the quality is not affected by the endogenous enzyme activity of the barley malt, barley malts of more varying standard as well as all adjunct grists could be used in beer production. It is the intention of this disclosure to provide such processes.

### SUMMARY OF THE INVENTION

In a first aspect the invention provides a process for the production of a wort, comprising the steps of; (a) forming a grist comprises grain; (b) forming a mash comprising said gist), (c) liquefying the mash in a step comprising jet-cooking; (d) saccharifying the liquefied mash. (e) optionally fermenting with a yeast, wherein the step (e) can be performed during or after step (d).

In further aspects the invention provides a wort produced by the process of the first aspect, a malt extract derived from a wort produced by the process the first aspect, and a beer produced by the process of the second aspect.

### DETAILED DESCRIPTION OF THE INVENTION

Brewing processes are well-known in the art, and generally involve the steps of malting, mashing, and fermentation. In the traditional brewing process the malting serves the purpose of converting insoluble starch to soluble starch, reducing complex proteins, generating color and flavor compounds, generating nutrients for yeast development, and the development of enzymes. The three main steps of the malting process are steeping, germination, and kilning.

Steeping includes mixing the barley kernels with water to raise the moisture level and activate the metabolic processes of the dormant kernel. In the next step, the wet barley is germinated by maintaining it at a suitable temperature and humidity level until adequate modification, i.e. such as degradation of starch and activation of enzymes, has been achieved. Kilning is the drying and conditioning of the malt where the temperature and duration applied decides how much of the enzyme activity that remains for the mashing step.

Mashing is the process of converting starch from the milled barley malt and solid adjuncts into fermentable and unfermentable sugars to produce wort of the desired composition. Traditional mashing involves mixing milled barley malt and adjuncts with water at a set temperature and volume to continue the biochemical changes initiated during the malting process. The mashing process is conducted over a period of time at various temperatures in order to activate the endogenous enzymes responsible for the degradation of proteins and carbohydrates. By far the most important change brought about in mashing is the conversion of starch molecules into fermentable sugars. The principal enzymes responsible for starch conversion in a traditional mashing process are alpha- and beta-amylases. Alpha-amylase very rapidly reduces insoluble and soluble starch by splitting starch molecules into many shorter chains that can be attacked by beta-amylase. The disaccharide produced is maltose. As the traditionally mashing processes utilize the endogenous enzymes of the barley malt the temperature is maintained below 70° C. as inactivation of the enzymes would otherwise occur.

After mashing, when all the starch has been broken down, it is necessary to separate the liquid extract (the wort) from the solids (spent grains). Wort separation is important because the solids contain large amounts of protein, poorly modified starch, fatty material, silicates, and polyphenols (tannins).

Following extraction and separation of the carbohydrates, proteins, and yeast nutrients from the spent grains, the hobs are added and the wort is conditioned by boiling in the kettle. Hops are used for their bittering, flavoring, and aroma-enhancing powers. Hops also have pronounced bacteriostatic activity that inhibits the growth of Gram-positive bacteria in the finished beer and, when in high enough concentrations, aids in precipitation of proteins. The purpose of wort boiling is to stabilize the wort and extract the desirable components from the hops. In the traditional mashing process the hobs must be added after the enzymatic hydrolysis of the starch has proceeded as the malt enzymes would otherwise be inhibited by the hobs components.

Further information on conventional brewing processes may be found in “Technology Brewing and Malting” by Wolfgang Kunze of the Research and Teaching Institute of Brewing, Berlin (VLB), 2nd revised Edition 1999, ISBN 3-921690-39-0.

Whereas the outcome of the conventional mashing process is highly dependent on the use of malt enzymes the present invention provides processes for producing wort and beer from all adjunct grists, malts produced with a much reduced malting time and thus low in enzymes, or just malts with substandard enzyme levels. The jet cooking applied during the liquefaction step ensures almost complete gelatinization. The high temperature of the jet cooking step ensures that the activity of the various endogenous enzymes of the grist material including unwanted activities such as lipoxygenase is eliminated. The application of a standardized mixture of enzymes enables conversion of a very high percentage of the grist starch into fermentable sugars and facilitates high extract recovery. As it will be evident from this disclosure the present invention provides a unique possibility to control the mashing process in respect to uniform wort quality and thereby to uniform beer quality. As the processes of the present invention includes only one heating step and no prolonged wort boiling step the energy consumption is reduced compared to conventional beer brewing processes. Finally the processes of the invention allows operating with very short production cycle times, not only in the brewing plant where the duration of mashing step may be significantly shortened but also in the malting plant where the malting process may be shortened or altogether omitted.

Definitions

Throughout this disclosure, various terms that are generally understood by those of ordinary skill in the arts are used. Several terms are used with specific meaning, however, and are defined by the following.

As used herein the term “grist” is understood as the starch or sugar containing material, i.e. malt and adjuncts, that's the basis for wort and beer production.

The term “malt” is understood as any malted cereal grain, in particular barley.

The term “adjunct” is understood as the part of the grist which is not barley malt. The adjunct may be any plant material rich in starch or sugar.

The term “mash” is understood as a slurry comprising the milled grist.

The term “wort” is understood as the unfermented liquor following extraction of the grist during mashing.

The term “beer” is understood as a fermented wort.

The term “homology” when used about polypeptide or DNA sequences and referred to in this disclosure is understood as the degree of homology between two sequences indicating a derivation of the first sequence from the second. The homology may suitably be determined by means of computer programs known in the art such as GAP provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-453. The following settings for polypeptide sequence comparison are used: GAP creation penalty of 3.0 and GAP extension penalty of 0.1.

According to the invention the grist may comprise any starch and/or sugar containing plant material derivable from tubers, roots, stems, leaves and seeds. Preferably the grist comprises grain, such as grain from barley, wheat, rye, oat, corn, rice, milo, millet and sorghum, and more preferably, at least 10%, or more preferably at least 15%, even more preferably at least 25%, or most preferably at least 35%, such as at least 50%, at least 75%, at least 90% or even 100% (w/w) of the grist of the wort is derived from grain. Most preferably the grist comprises malted grain, such as barley malt.

The grist may comprise grain with hull and/or germ or grain from which hull and/or germ have been removed. To avoid plugging up the jet cooker and/or the formation of off-flavors in the finished beer grain grist material is preferably freed of hull and germ before forming the mash. Preferably grist material comprising grain is dry milled before forming the mash as this allows removal of hull and germ. Dry milling may be applied to malted as well as unmalted grain. As hull and germ are removed from the grain before grist formation the amount of insoluble matter will be small and a wort separation step such as follows mashing in a conventional brewing process can be omitted.

Adjuncts comprising readily fermentable carbohydrates such as sugars or syrups may be added to the mash before the liquefaction step (c) but is typically added after jet cooking and most typically prior to or during the saccharification step.

Fermentation may be performed as at high gravity and the dry solid percentage (DS %) in the mash of the first and second aspect may be in the range from 1-50%, in particular 5-40%, such as 10-30%, such as 15-25%.

The mash is preferably heated to between 55-95° C., and alpha-amylase activity is added to initiate liquefaction (b₀, primary liquefaction) before jet-cooking (b₁) at a temperature between 85-140° C. to achieve almost complete gelatinization of the mash. Then the mash is cooled to 60-95° C. and more alpha-amylase activity is added to finalize hydrolysis (b₂, secondary liquefaction). The liquefaction process is carried out at pH 4.5-6.5, in particular at a pH between 5 and 6. The alpha-amylase applied in the liquefaction step (c) may be any suitable alpha-amylase, but especially contemplated are the alpha-amylase having an amino add sequence having at least 90% homology to SEQ ID NO:4 in WO99/19467, such as at least 92%, at least 95%, at least 96%, at least 97%, at least 98%, or particularly at least 99% homology.

During the liquefaction step (c) grist starch material is broken down into maltodextrins mostly of a DE higher than 4. To produce low molecular sugars DE1-3 that can be metabolized by the yeast, the maltodextrin from the liquefaction must be further hydrolyzed during the saccharification step (d). The hydrolysis in the saccharification step (d) is carried out in the presence of an enzyme selected from the list comprising glucoamylase, maltogenic alpha-amylase, beta-amylase, cellulase, pentosanase and protease.

In one embodiment saccharification is performed as a full saccharification step of typically 90-180 minutes at 30-65° C., typically at about 60° C., and at a pH between 4 and 5, normally at about pH 4.5 and resulting in a wort.

In another embodiment the saccharification step (d) is performed as a pre-saccharification of typically 40-90 minutes at 30-65° C., typically at about 60° C., and at a pH between 4 and 5, normally at about pH 4.5. If not completed during the saccharification step (d) the hydrolysis of the starch is continued during the following fermentation step (d).

In a preferred embodiment the wort produced by the process of the first aspect is fermented to obtain a beer. Fermentation of the wort includes pitching the wort with a yeast, especially yeasts selected from Saccharomyces spp. such as S. cerevisiae and S. uvarum, including natural or artificially produced variants of these organisms. Fermentation may be performed at a temperature of between 8° C. and 33° C., but preferably the temperature is from 9° C. to 16° C., such as 10° C., 11° C., 12° C., 13° C., 14° C. or 15° C. In a preferred embodiment of the first aspect the steps (c) and (d), i.e. saccharification and fermentation, are carried out simultaneously (Simultaneous Saccharification and Fermentation=SSF). The enzymatic starch hydrolysis thus proceeds at the low temperature favoring the fermenting organism. The fermentation performed as a separate fermentation step, or the saccharification and fermentation performed as one SSF step, may proceed for 4 to 10 days, preferably for at least 5 days, such as 6, 7, 8 or 9 days.

In a preferred embodiment the saccharification step (d) and/or the fermentation step (d) are carried out in the presence of a plant cell wall degrading enzyme, such as a cellulase or a pentosanase.

In a preferred embodiment the saccharification step (d) and/or the fermentation step (d) is carried out in the presence of a yeast cell wall degrading enzyme. The yeast cell wall degrading enzyme may be selected from the group comprising beta-1,3-glucanase, 1,6-beta-glucanase, laminarinase, chitinase, mannanase, alpha-1,3-glucanase (mutanase), and protease. In a preferred embodiment the yeast cell wall degrading enzyme is a preparation derived from Trichoderma, in particular Trichderma harzianum, such as the product GLUCANEX™ (available from Novozymes A/S).

Preferably the saccharification step (d) and/or the fermentation step (d) are carried out in the presence of an acetolactate decarboxylase. Acetolactate decarboxylase prevents the formation of diacetyl by catalyzing the decarboxylation of alpha-acetolactate to acetoin whereby the maturation period can be eliminated or greatly reduced.

The hops may be added at any step in the process of the invention. Especially contemplated are the embodiments, wherein the hops, as milled whole hops or pellets or as extracts are added to the mash prior to the jet cooking step (b1), prior to the saccharification step (d) and/or fermentation step (e), or wherein the hops are added to the mash after the fermentation step (e). A preferred embodiment of the present invention comprises forming a mash where the hop components are present during the jet cooking step (b1) and the following enzymatic hydrolysis of the grist starch, e.g. where the hops, preferably in the form of milled whole hops or milled hops pellets, are added to the mash prior to the jet cooking step (b1). This is possible because the exogenously supplied enzymes applied in the present invention are less sensitive to the hops components than the enzymes from barley malt and/or the exogenously supplied enzymes can be added in excess amounts relative to the concentrations present in a conventional process relying on enzymes from barley malt.

The wort of the first aspect maybe further processed to a malt extract or used for the manufacture of an unfermented malt beverage.

The wort produced by the process of the first aspect of the invention may be blended with a second wort prior to fermentation. This second wort may be a product of the first aspect of the present invention or the product of a conventional product.

The beer produced by the process of the first embodiment of the first aspect of the present invention may, in order to produce a beer, be blended with a second beer. This second beer may also be a beer of the first embodiment of the first aspect of the present invention or it may be the product of a conventional process.

The fermented wort may be passed through a centrifugation system to secure the separation of remaining grist solids and yeast cells and the recovery of clear beer. The yeast cells may be washed and recycled back into the process prior to the fermentation step (e). Silica hydrogel may be added to the beer to increase the colloidal stability and/or the beer may be filtered through kieselguhr to render the beer bright. Finally the beer may be pasteurized to inactivate enzymes and hereafter cooled for maturation. Prior to packaging in bottles, cans or kegs the beer is preferably carbonized.

The processes of the second aspect of the invention may be used for the production of any type of beer. Preferred beer types comprise ales, strong ales, stouts, porters, lagers, bitters, export beers, malt liquors, happoushu, high-alcohol beer, low-alcohol beer, low-calorie beer or light beer.

Enzymes

The enzymes to be applied in the present invention may be derived from any source, preferably from a plant or an alga, and more preferably from a microorganism, such as from a bacteria or a fungi.

Alpha-Amylase (EC 3.2.1.1)

A particular alpha-amylase to be used in the processes of the invention may be any fungal alpha-amylase. Especially contemplated are fungal alpha-amylases which exhibit a high homology, i.e. at least 50%, at least 55%, at least 60%, at least 65%, at least 70%, at least 75%, at least 80%, at least 85% or even at least 90% homology to the amino acid sequence shown in SEQ ID No. 10 in WO96/23874. Fungal alpha-amylases may be added in an amount of 1-1000 AFAU/kg DM, preferably from 2-500 AFAU/kg DM, preferably 20-100. AFAU/kg DM.

Another particular alpha-amylase enzyme to be used in the processes of the invention may be a Bacillus alpha-amylase. Well-known Bacillus alpha-amylases include alpha-amylase derived from a strain of B. licheniformis, B. amyloliquefaciens, and B. stearothermophilus. Other Bacillus alpha-amylases include alpha-amylase derived from a strain of the Bacillus sp. NCIB 12289, NCIB 12512, NCIB 12513 or DSM 9375, all of which are described in detail in WO95/26397, and the alpha-amylase described by Tsukamoto et al., Biochemical and Biophysical Research Communications, 151 (1988), pp. 25-31. In the context of the present invention a contemplated Bacillus alpha-amylase is an alpha-amylase as defined in WO99/19467 on page 3, line 18 to page 6, line 27. A preferred alpha-amylase has an amino acid sequence having at least 90% homology to SEQ ID NO:4 in WO99/19467, such as at least 92%, at least 95%, at least 96%, at least 97%, at least 98%, or particularly at least 99%.

Bacillus alpha-amylases may be added in the amounts of 1.0-1000 NU/kg dm, preferably from 2.0-500 NU/kg dm, preferably 10-200 NU/kg dm.

Maltogenic Alpha-Amylase

Maltogenic alpha-amylases (glucan 1,4-alpha-maltohydrolase) (E.C. 3.2.1.133) are able to hydrolyse amylose and amylopectin to maltose in the alpha-configuration. Furthermore, a maltogenic alpha-amylase is able to hydrolyse maltotriose as well as cyclodextrin. Specifically contemplated maltogenic alpha-amylases may be derived from Bacillus sp., preferably from Bacillus stearothermophilus, most preferably from Bacillus stearothermophilus C599 such as the one described in EP 120.693. This particular maltogenic alpha-amylase has the amino acid sequence shown as amino acids 1-686 of SEQ ID NO:1 in U.S. Pat. No. 6,162,628. A preferred maltogenic alpha-amylase has an amino acid sequence having at least 90% homology to amino acids 1-686 of SEQ ID NO:1 in U.S. Pat. No. 6,162,628 preferably at least 92%, at least 95%, at least 96%, at least 97%, at least 98%, or particularly at least 99%. Most preferred variants of the maltogenic alpha-amylase comprise the variants disclosed in WO99/43794. Contemplated variants and hybrids are described in WO96/23874, WO97/41213, and WO99/19467. Specifically contemplated is a recombinant B. stearothermophilus alpha-amylase variant with the mutations; I181*+G182*+N193F.

Maltogenic alpha-amylases may be added in amounts of 0.1-1000 MANU/kg dm, preferably from 1-100 MANU/kg dm, preferably 5-25 MANU/kg dm.

Beta-Amylase

Another enzyme to be used in the processes of the invention may be a beta-amylase (E.C 3.2.1.2).

Beta-amylases have been isolated from various plants and microorganisms (W. M. Fogarty and C. T. Kelly, Progress in Industrial Microbiology, vol. 15, pp. 112-115, 1979). These beta-amylases are characterized by having optimum temperatures in the range from 40° C. to 65° C. and optimum pH in the range from 4.5 to 7.0. Specifically contemplated beta-amylase include the beta-amylases SPEZYME® BBA 1500, SPEZYME® DBA and OPTIMALT™ ME, OPTIMALT™ BBA from Genencor Int. as well as the beta-amylases NOVOZYM™ WBA from Novozymes A/S. Beta-amylases may be added in effective amounts well known to the person skilled in the art.

Glucoamylase

An enzyme to be used in the processes of the invention may be a glucoamylase (E.C.3.2.1.3) derived from a microorganism or a plant. Preferred are glucoamylases of fungal or bacterial origin selected from the group consisting of Aspergillus glucoamylases, in particular A. niger G1 or G2 glucoamylase (Boel et al. (1984), EMBO J. 3 (5), p. 1097-1102), or variants thereof, such as disclosed in WO92100381 and WO00/04136; the A. awamori glucoamylase (WO084/02921), A. oryzae (Agric. Biol. Chem. (1991), 55 (4), p. 941-949), or variants or fragments thereof.

Other contemplated Aspergillus glucoamylase variants include variants to enhance the thermal stability: G137A and G139A (Chen et al. (1996), Prot. Engng. 9, 499-505); D257E and D293E/Q (Chen et al. (1995), Prot. Engng. 8, 575-582); N182 (Chen et al. (1994), Biochem. J. 301, 275-281); disulphide bonds, A246C (Fierobe et al. (1996), Biochemistry, 35, 8698-8704; and introduction of Pro residues in position A435 and S436 (Li et al. (1997), Protein Engng. 10, 1199-1204). Other contemplated glucoamylases include Talaromyces glucoamylases, in particular derived from Talaromyces emersonii (WO99/28448), Talaromyces leycettanus (U.S. Pat. No. Re. 32,153), Talaromyces duponti, Talaromyces thermophilus (U.S. Pat. No. 4,587,215). Bacterial glucoamylases contemplated include glucoamylases from the genus Clostridium, in particular C. thermoamylolyticum (EP 135,138), and C. thermohydrosulfuricum (WO86/01831). Preferred glucoamylases include the glucoamylases derived from Aspergillus oryzae, such as a glucoamylase having at least 90%, at least 92%, at least 95%, at least 96%, at least 97%, at least 98%, or particularly at least 99%. even at least 90% homology to the amino acid sequence shown in SEQ ID NO:2 in WO00/04136. Also contemplated are the commercial products AMG 200L; AMG 300 L; SAN™ SUPER and AMG™ E (from Novozymes); OPTIDEX™ 300 (from Genencor Int.); AMIGASE™ and AMIGASE™ PLUS (from DSM); G-ZYME™ G900 (from Enzyme Bio-Systems); G-ZYME™ G990 ZR (A. niger glucoamylase and low protease content). Glucoamylases may be added in effective amounts well known to the person skilled in the art.

Acetolactate Decarboxylase

The acetolactate decarboxylase (E.C. 4.1.1.5) used according to the invention may be derived from a strain of Bacillus brevis such as the preparation available from Novozymes A/S under the trade name Maturex. Acetolactate decarboxylase may be added in effective amounts well known to the person skilled in the art.

Pentosanase

Pentosanases include enzymes within the endo-1,4-b-xylanases (EC 3.2.1.8.), the xylan endo-1,3-b-xylosidase (EC 3.2.1.32), the xylan 1,3-b-xylosidases (EC 3.2.1.72), and the glucuronoarabinoxylan endo-1,4-b-xylanases (EC 3.2.1.136). The enzymes may be derived from any source such as from the organisms Thermomyces lanuginosus, Trichoderma longibrachiatum (aka T. reesei), Disporotrichum dimorphosporum, Aspergillus niger, or Bacillus subtilis

Cellulase

Cellulase (E.C. 3.2.1.4), or endo-1,4-beta-glucanase, may be of microbial origin, such as derivable from a strain of a filamentous fungus (e.g., Aspergillus, Trichoderma, Humicola, Fusarium). Specific examples include the endo-1,4-beta-glucanase obtainable from H. insolens and defined by the amino acid sequence of FIG. 14 in WO 91/17244, and the 43 kD H. insolens endo-1,4-beta-glucanase described in WO 91/17243. Also contemplated are endo-1,4-beta-glucanases having at least 90% homology to the amino acid sequence disclosed as SEQ.ID.NO:1 in Danish patent application PA2002 00130, such as at least 92%, at least 95%, at least 96%, at least 97%, at least 98%, or particularly at least 99%.

Commercially available cellulase preparations which may be used include CELLUCLAST®, CELLUZYME®, CEREFLO® and ULTRAFLO® (available from Novozymes A/S), LAMINEX™ and SPEZYME® CP (available from Genencor Int.) and ROHAMENT® 7069 W (available from Röhm, Germany).

Beta-1,4-glucanases may be added in the amounts of 1.0-10000 BGU/kg dm, preferably from 10-5000 BGU/kg dm, preferably from 50-1000 BGU/kg dm and most preferably from 100-500 BGU/kg dm.

In a preferred embodiment the beta-1,4-glucanase activity may added as a multi-enzyme preparation comprising a wide range of carbohydrases, incl. arabinanase, cellulase, beta-glucanase, hemicellulase and xylanase such as a preparation derived from Aspergillus aculeatus CBD 101.43 and available from Novozymes as Viscozyme.

Beta-1,3-Glucanases and Laminarinases,

Beta-1,3-glucanase includes the group of endo-beta-1,3-glucanases also called laminarinases (E.C. 3.2.1.39 and E.C. 3.2.1.6, Enzyme Nomenclature, Academic Press, Inc, 1992).

Chitinases

Chitinases include the groups of exo-chitinases and endochitinases. Exochitinases are also referred to as chitobiosidases or beta-N-acetylhexosaminidases (E.C. 3.2.1.52, Enzyme Nomenclature, Academic Press, Inc., 1992). Endochitinases (E.C. 3.4.1.14) are enzymes, which randomly hydrolyse N-acetyl-beta-D-glucosaminide 1,4-beta-linkages of chitin and chitodextrins.

Fungal chitinases include the ones described by Harman et al., (1993), Mol. Plant Pathology 83, 313-318; Blaiseau and Lafay, (1992), Elsevier science publisher B. V., 243-248; and Gracia, (1994), Current Genetics 27, 83-89. Also contemplated chitinases include the ones described in WO 92/22314 (Cornell Research Foundation, INC) describes two chitinases from Trichoderma harzianum P1 (ATCC 74058); WO 94/24288 and WO 94/02598 (Cornell Research Foundation, INC) disclosing two chitinases from Trichoderma harzianum P1 (ATCC 74058); and EP 440.304 which concerns plants exhibiting a relative overexpression of at least one gene encoding intracellular chitinase and intra- or extracellular beta-1,3 glucanase.

Mannanases

Mannanases have been identified in several Bacillus organisms. For example, Talbot et al., Appl. Environ. Microbiol., Vol. 56, No. 11, pp. 3505-3510 (1990) describes a beta-mannanase derived from Bacillus stearothermophilus in dimer form having molecular weight of 162 kDa and an optimum pH of 5.5-7.5. Mendoza et al., World J. Microbiol. Biotech., Vol. 10, No. 5, pp. 551-555 (1994) describes a beta-mannanase derived from Bacillus subtilis having a molecular weight of 38 kDa, an optimum activity at pH 5.0 and 55° C. and a pI of 4.8. JP-03047076 discloses a beta-mannanase derived from Bacillus sp., having a molecular weight of 37±3 kDa measured by gel filtration, an optimum pH of 8-10 and a pI of 5.3-5.4. JP-63056289 describes the production of an alkaline, thermostable beta-mannanase which hydrolyses beta-1,4-D-mannopyranoside bonds of e.g. mannans and produces manno-oligosaccharides. JP-63036774 relates to the Bacillus microorganism FERM P-8856, which produces beta-mannanase and beta-mannosidase at an alkaline pH. JP-08051975 discloses alkaline beta-mannanases from alkalophilic Bacillus sp. AM-001. A purified mannanase from Bacillus amyloliquefaciens useful in the bleaching of pulp and paper and a method of preparation thereof is disclosed in WO 97/11164. WO 94/25576 discloses an enzyme from Aspergillus aculeatus, CBS 101.43, exhibiting mannanase activity, which may be useful for degradation or modification of plant or algae cell wall material. WO 93/24622 discloses a mannanase isolated from Trichoderma reseei useful for bleaching lignocellulosic pulps.

Mutanases

Mutanases are alpha-1,3-glucanases (also known as α-1,3-glucanohydrolases), which degrade the alpha-1,3-glycosidic linkages in mutan. Mutanases have been described from two species of Trichoderma (Hasegawa et al., (1969), Journal of Biological Chemistry 244, p. 5460-5470; Guggenheim and Haller, (1972), Journal of Dental Research 51, p. 394-402) and from a strain of Streptomyces (Takehara et al., (1981), Journal of Bacteriology 145, p. 729-735), Cladosporium resinae (Hare et al. (1978), Carbohydrate Research 66, p. 245-264), Pseudomonas sp. (U.S. Pat. No. 4,438,093), Flavobacterium sp. (JP 77038113), Bacillus circulanse (JP 63301788) and Aspergillus sp. A mutanase gene from Trichoderma harzianum has been cloned and sequenced (Japanese Patent No. 4-58889-A from Nissin Shokuhin Kaisha LDT). A preferred mutanase is described in WO 98/00528 (from Novozymes).

Preferred cell wall degrading enzymes have an optimum activity within the pH and temperature of the fermentation step, i.e., at acidic pH, in particular at a pH between 3-6, preferably between pH 4-5 and a temperature between 26-34° C., in particular about 32° C.

Protease

Suitable proteases include microbial proteases, such as fungal and bacterial proteases. Preferred proteases are acidic proteases, i.e., proteases characterized by the ability to hydrolyze proteins under acidic conditions below pH 7.

Contemplated acid fungal proteases include fungal proteases derived from Aspergillus, Mucor, Rhizopus, Candida, Coriolus, Endothia, Enthomophtra, Irpex, Penicillium, Sclerotiumand Torulopsis. Especially contemplated are proteases derived from Aspergillus niger (see, e.g., Koaze et al., (1964), Agr. Biol. Chem. Japan, 28, 216), Aspergillus saitoi (see, e.g., Yoshida, (1954) J. Agr. Chem. Soc. Japan, 28, 66), Aspergillus awamori (Hayashida et al., (1977) Agric. Biol. Chem., 42(5), 927-933, Aspergillus aculeatus (WO 95/02044), or Aspergillus oryzae, such as the pepA protease; and acidic proteases from Mucor pusillus or Mucor miehei.

Contemplated are also neutral or alkaline proteases, such as a protease derived from a strain of Bacillus. A particular protease contemplated for the invention is derived from Bacillus amyloliquefaciens and has the sequence obtainable at Swissprot as Accession No. P06832. Also contemplated are the proteases having at least 90% homology to the amino acid sequence obtainable at Swissprot as Accession No. P06832 such as at least 92%, at least 95%, at least 96%, at least 97%, at least 98%, or particularly at least 99%.

The proteases are responsible for reducing the overall length of high-molecular-weight proteins to low-molecular-weight proteins in the mash. The low-molecular-weight proteins are a necessity for yeast nutrition and the high-molecular-weight-proteins ensure foam stability. Thus it is well-known to the skilled person that protease should be added in a balanced amount which at the same time allows amble free amino acids for the yeast and leaves enough high-molecular-weight-proteins to stabilize the foam. Proteases may be added in the amounts of 0.1-1000 AU/kg dm, preferably 1-100 AU/kg dm and most preferably 5-25 AU/kg dm.

Materials and Methods

Enzymes Applied

The following enzymes is applied; an alpha-amylase from B. stearothermophilus having the amino acid sequence disclosed as SEQ.NO:4 in WO99/19467 with the mutations: I181*+G182*+N193F, a glucoamylase derived from Aspergillus oryzae having the amino acid sequence shown in WO00/04136 as SEQ ID No: 2 or one of the disclosed variants, a maltogenic alpha-amylase having the amino acid sequence 1-686 of SEQ ID NO:1 in patent application WO1016340, a protease derived from Bacillus amyloliquefaciens and having the sequence disclosed as Swissprot Accession No P06832, an alpha-acetolactate decarboxylase derived from brevis, and a preparation derived from Aspergillus aculeatus CBD 101.43 comprising beta-glucanase activity.

Methods

Proteolytic Activity (AU)

The proteolytic activity may be determined with denatured hemoglobin as substrate. In the Anson-Hemoglobin method for the determination of proteolytic activity denatured hemoglobin is digested, and the undigested hemoglobin is precipitated with trichloroacetic acid (TCA). The amount of TCA soluble product is determined with phenol reagent, which gives a blue color with tyrosine and tryptophan.

One Anson Unit (AU) is defined as the amount of enzyme which under standard conditions (i.e. 25□C, pH 7.5 and 10 min. reaction time) digests hemoglobin at an initial rate such that there is liberated per minute an amount of TCA soluble product which gives the same color with phenol reagent as one milliequivalent of tyrosine.

A folder AF 4/5 describing the analytical method in more detail is available upon request to Novozymes A/S, Denmark, which folder is hereby included by reference.

Alpha-Amylase Activity (NU)

The amylolytic activity may be determined using potato starch as substrate. This method is based on the break-down of modified potato starch by the enzyme, and the reaction is followed by mixing samples of the starch/enzyme solution with an iodine solution. Initially, a blackish-blue color is formed, but during the break-down of the starch the blue color gets weaker and gradually turns into a reddish-brown, which is compared to a colored glass standard.

One Kilo Novo alpha amylase Unit (KNU) equals 1000 NU. One KNU is defined as the amount of enzyme which, under standard conditions (i.e. at 37° C.±0.05; 0.0003 M Ca2+; and pH 5.6) dextrinizes 5.26 g starch dry substance Merck Amylum solubile.

A folder AF 9/6 describing this analytical method in more detail is available upon request to Novozymes A/S, Denmark, which folder is hereby included by reference.

Maltogenic Alpha-Amylase Activity (MANU)

One Maltogenic Amylase Novo Unit (MANU) is defined as the amount of enzyme which under standard will cleave one micro mol maltotriose per minute. The standard conditions are 10 mg/ml maltotriose, 37° C., pH 5.0, and 30 minutes reaction time. The formed glucose is converted by glucose dehydrogenase (GlucDH, Merck) to gluconolactone under formation of NADH, which is determined by photometric at 340 nm. A detailed description of the analytical method (EAL-SM-0203.01) is available on request from Novozymes.

Glucoamylase Activity (AGU)

The Novo Glucoamylase Unit (AGU) is defined as the amount of enzyme, which hydrolyzes 1 micromole maltose per minute at 37° C. and pH 4.3.

The activity is determined as AGU/ml by a method modified after (AEL-SM-0131, available on request from Novozymes) using the Glucose GOD-Perid kit from Boehringer Mannheim, 124036. Standard: AMG-standard, batch 7-1195, 195 AGU/ml. 375 microL substrate (1% maltose in 50 mM Sodium acetate, pH 4.3) is incubated 5 minutes at 37° C. 25 microL enzyme diluted in sodium acetate is added. The reaction is stopped after 10 minutes by adding 100 microL 0.25 M NaOH. 20 microL is transferred to a 96 well microtitre plate and 200 microL GOD-Perid solution (124036, Boehringer Mannheim) is added. After 30 minutes at room temperature, the absorbance is measured at 650 nm and the activity calculated in AGU/ml from the AMG-standard. A detailed description of the analytical method (AEL-SM-0131) is available on request from Novozymes.

Beta-1,4-Glucanase Activity

The cellulytic activity of bacterial beta-glucanase may be measured in beta-glucanase units (BGU). Beta-1,4-glucanase reacts with beta-glucan to form glucose or reducing carbohydrate which is determined as reducing sugar using the Somogyi-Nelson method. 1 beta-glucanase unit (BGU) is the amount of enzyme which, under standard conditions, releases glucose or reducing carbohydrate with a reduction capacity equivalent to 1 μmol glucose per minute. Standard conditions are 0.5% beta-glucan as substrate at pH 7.5 and 30° C. for a reaction time of 30 minutes. A detailed description of the analytical method (EB-SM-0070.02/01) is available on request from Novozymes A/S.

The cellulytic activity of fungal beta-glucanase may be measured in fungal beta-glucanase units (FBG). Method and standard conditions are as for BGU except that pH is 5.0. A detailed description of the analytical method (EB-SM-0338.02/03) is available on request from Novozymes A/S.

Beta-Amylase Activity (DP°)

The activity of SPEZYME® BBA 1500 is expressed in Degree of Diastatic Power (DP°). It is the amount of enzyme contained in 0.1 ml of a 5% solution of the sample enzyme preparation that will produce sufficient reducing sugars to reduce 5 ml of Fehling's solution when the sample is incubated with 100 ml of substrate for 1 hour at 20° C.

Pentosanase Activity

Pentosanase activity is expressed in PTU and determined according to the Novozymes standard method. A detailed description of the analytical method (EAL-SM-0371.01/01) is available on request from Novozymes

Additional Methods

Methods for analysis of raw products, wort, beer etc. can be found in Analytica-EBC, Analysis Committee of EBC, the European Brewing Convention (1998), Verlag Hans Carl Geranke-Fachverlag.

### EXAMPLES

### Example 1

52.5 kg milled and hull free barley malt, 52.5 kg milled and hull free barley, 45.0 kg milled maize grits and isomerized hop extract equivalent to 0.08 kg alpha acid is mixed with 350 litre of cold water in a stainless steel tank with stirring. Alpha-amylase 145 KNU/kg grist and the suspension is pumped through a jet cooker at 85° C. a flow rate of 250 litre/hour keeping the temperature at 85° C. with a holding time 90 minutes in the pre-mash kettle. 100 litre of water is added and the mixture is cooled to a fermentation temperature of 15° C. Propagated brewers yeast and glucoamylase 150 AGU/kg grist, maltogenic amylase 3000 MANU/kg grist, protease 1 AU/kg grist, beta glucanase 75 FBG/kg of grist and alpha-acetolactate decarboxylase 200 ADU/kg of grits is added. Optionally is pH adjusted to pH=4.5 using 6 N HCl. A simultaneous mashing and fermentation process (SMF) is carried out for 7 days. The beer is separated from suspended material including yeast, matured at 5° C. for 7 days, filtered, and sent to the bright beer tank.

### Example 2

52.5 kg milled and hull free barley malt, 52.5 kg milled and hull free barley, 45.0 kg milled maize grits and isomerized hop extract equivalent to 0.08 kg alpha acid is mixed with 350 litre of cold water in a stainless steel tank with stirring. Alpha-amylase 145 KNU/kg grist and the suspension is pumped through a jet cooker at a flow rate of 250 litre/hour keeping the post temperature at 85-95° C. with a holding time of 90 minutes in the pre-mash kettle. Hereafter the pre-mash is cooled to 55° C. and glucoamylase 150 AGU/kg grist, maltogenic amylase 3000 MANU/kg grist, protease 1 AU/kg grist, beta glucanase 75 FBG/kg of grist. Optionally pH is adjusted to pH=4.5 using 6 N HCl. After cooling to the fermentation temperature 15° C. propagated brewers yeast and alpha-acetolactate decarboxylase, 200 ADU/kg of grits is added and fermentation is carried out for 7 days. The beer is separated from suspended material including yeast, matured/stored at 5° C. for 7 days, filtered, and 100 litre of micro filtered well water is added. Hereafter the final beer is sent to the bright beer tank.

1-19. (canceled)

20. A process for the production of a beer; comprising the steps of;
(a) forming a grist comprising grain;
(b) forming a mash comprising the grist from step (a);
(c) liquefying the mash in a step comprising jet-cooking;
(d) saccharifying the liquefied mash;
(e) optionally fermenting the mash with a yeast;
wherein the step (e) can be performed during or after step (d).

21. The process of claim 20, wherein the grist comprising grain from which hull and/or germ have been removed

22. The process of claim 20, wherein the liquefaction step (c) comprises the following sub-steps;
(c1) jet-cooking the mash at a temperature between 85-140° C.;
(c2) holding the mash at a temperature between 55-95° C.;
wherein step (c1) and/or step (c2) is carried out in the presence of an alpha-amylase.

23. The process of claim 20, wherein the saccharification step (d) and/or the fermentation step (e) is carried out in the presence of at least one of the following enzyme: glucoamy-lase, maltogenic alpha-amylase, beta-amylase, cellulase, pentosanase and protease.

24. The process of claim 20, wherein the saccharification step (d) and/or the fermentation step (e) are carried out in the presence of a yeast cell wall degrading enzyme.

25. The process of claim 24, wherein the yeast cell wall degrading enzyme is selected from the group comprising beta-1,3-glucanase, 1,6-beta-glucanase, laminarinase, chitinase, man-nanases, alpha-1,3-glucanase and protease.

26. The process of claim 24, wherein the yeast cell wall degrading enzyme is a preparation derived from Trichoderma harzianum.

27. The process of claim 20, wherein the saccharification step (d) and/or the fermentation step (e) is carried out in the presence of an acetolactate decarboxylase.

28. The process of claim 20, wherein at least 1%, at least 5%, at least 10%, or at least 25%, such as at least 50%, at least 75%, at least 90% or 100% (w/w) of the grist is grain.

29. The process of claim 20, wherein the grist comprises malted grain.

30. The process of claim 20, wherein the grist comprises malted or unmalted barley.

31. The process of claim 20, wherein the grist grain is dry milled.

32. The process of claim 20, wherein hops are added to the mash prior to the jet cooking step (b1).

33. The process of claim 20, wherein hops are added to the mash prior to the fermentation step (e).

34. The process of claim 20, wherein hops are added to the mash after the fermentation step (e).

35. The process of claim 20, wherein the beer is ale, strong ale, bitter, stout, porter, lager, export beer, malt liquor, barley wine, happoushu, high-alcohol beer, low-alcohol beer, low-calorie beer or light beer.

36. A wort produced by the process of claim 20.

37. A malt extract derived from a wort produced by the process of claim 20.

38. A beer produced by the process of claim 20.
